(19) United States
(12) Patent Application Publication
(10) Pub. No.: US 2013/0017130 A1
(43) Pub. Date: Jan. 17, 2013

(54) BUFFY COAT SEPARATOR FLOAT SYSTEMS AND METHODS

(71) Applicant: Thomas D. Haubert, Columbus, OH (US)

(72) Inventor: Thomas D. Haubert, Columbus, OH (US)

(21) Appl. No.: 13/638,024

(22) PCT Filed: Mar. 30, 2011
(86) PCT No.: PCT/US11/30420

§ 371 Date: Sep. 28, 2012

Related U.S. Application Data
(60) Provisional application No. 61/318,929, filed on Mar. 30, 2010.
(60) Provisional application No. 61/372,905, filed on Aug. 12, 2010.

(51) Int. Cl. G01N 1/34

(52) U.S. Cl. 422/533

(57) ABSTRACT

Tube and float systems for separation and axial expansion of the buffy coat are provided. Generally, the systems include a flexible sample tube and a rigid separator float having a specific gravity intermediate that of red blood cells and plasma. The sample tube has an elongated sidewall having a first cross-sectional inner diameter. The float has a main body portion and one or more support members protruding from the main body portion to engage and support the sidewall of the sample tube. During centrifugation, the centrifugal force enlarges the diameter of the tube to permit density-based axial movement of the float in the tube. After centrifugation is ended, the tube sidewall returns to its first diameter, thereby capturing the float and trapping the buffy coat constituents in an annular volume. Several different systems for capturing and retrieving the buffy coat constituents are described.

This application claims priority to U.S. Provisional Patent Application Ser. No. 61/318,929, filed on Mar. 30, 2010, and to U.S. Provisional Patent Application Ser. No. 61/372,905, filed on Aug. 12, 2010. The disclosure of these applications is hereby fully incorporated by reference.

### BACKGROUND OF THE DISCLOSURE

The present disclosure relates generally to density-based fluid separation, and in particular to improved sample tubes and float designs for the separation, identification, and/or quantification of fluid compounds by axial expansion, and methods employing the same. The present disclosure finds particular application in blood separation and axial expansion of the buffy coat layers, and will be described with particular reference thereto.

Quantitative Buffy Coat (QBC) analysis is routinely performed in clinical laboratories for the evaluation of whole blood. The buffy coat is a series of thin, light-colored layers of white cells that form between the layer of red cells and the plasma when unclotted blood is centrifuged or allowed to stand.

QBC analysis techniques generally employ centrifugation of small capillary tubes containing anticoagulated whole blood, to separate the blood into essentially six layers: (1) packed red cells, (2) reticulocytes, (3) granulocytes, (4) lymphocytes/monocytes, (5) platelets, and (6) plasma. The buffy coat consists of the layers, from top to bottom, of platelets, lymphocytes and granulocytes and reticulocytes.

Based on examination of the capillary tube, the length or height of each layer is determined during the QBC analysis and converted into a cell count, thus allowing quantitative measurement of each layer. The length or height of each layer can be measured with a manual reading device, i.e., a magnification eyepiece and a manual pointing device, or photometrically by an automated optical scanning device that finds the layers by measuring light transmittance and fluorescence along the length of the tube. A series of commonly used QBC instruments are manufactured by Becton-Dickinson and Company of Franklin, Lakes, N.J.

Since the buffy coat layers are very thin, the buffy coat is often expanded in the capillary tube for more accurate visual or optical measurement by placing a plastic cylinder, or float, into the tube. The float has a density less than that of red blood cells (approximately 1.090 g/ml) and greater than that of plasma (approximately 1.028 g/ml) and occupies nearly all of the cross-sectional area of the tube. The volume-occupying float, therefore, generally rests on the packed red blood cell layer and expands the axial length of the buffy coat layers in the tube for easier and more accurate measurement.

There exists a need in the art for an improved sample tube and float system and method for separating blood and/or identifying circulating cancer and/or other rare cells, organisms or particulates or objects (i.e., stem cells, cell fragments, virally-infected cells, trypanosomes, etc.) in the buffy coat or other layers in a blood sample. However, the number of cells expected to be typically present in the buffy coat is very low relative to the volume of blood, for example, in the range of about 1-100 cells per millimeter of blood, thus making the measurement difficult, particularly with the very small sample sizes employed with the conventional QBC capillary tubes and floats.

The present disclosure contemplates new and improved blood separation assemblies and methods that overcome the above-referenced problems and others.

### BRIEF DESCRIPTION

The present application discloses, in various embodiments, apparatuses and methods for separating and axially expanding the buffy coat constituents in a blood sample. The apparatuses include separator floats and sample tubes.

Disclosed herein are methods of separating and axially expanding buffy coat constitutents in a blood sample; detecting target cells in a blood sample; and capturing or extracting buffy coat constitutents/target cells in a blood sample. Those methods require introducing the blood sample and a rigid volume-occupying float into a flexible sample tube. The rigid float has a specific gravity intermediate that of red blood cells and plasma, and comprises a main body portion spacedly surrounded radially by the sidewall of the sample tube to form an annular volume therebetween; and one or more support members protruding from the main body portion and engaging the sidewall. The sample tube is centrifuged at a rotational speed that causes enlargement of the sidewall to a diameter sufficiently large to permit axial movement of the float, separation of the blood into discrete layers, and movement of the float into alignment with at least the buffy coat constituents of the blood sample. The rotational speed is reduced to cause the sidewall to capture the float and trap buffy coat constituents in the annular volume, which might be divided into one or more analysis areas.

In some embodiments, the blood sample and the float are introduced into a flexible sleeve. A compressible material is fed into a sample tube, and the flexible sleeve is placed into the sample tube such that (i) the compressible material is between the sample tube and the flexible sleeve, and (ii) the compressible material applies pressure sufficient to cause the flexible sleeve to engage the float. During centrifugation, the pressure of the compressible material against the flexible sleeve is reduced, permitting movement of the float into alignment with at least the buffy coat constituents of the blood sample. Upon reducing the rotational speed, the compressible material again applies pressure that causes the flexible sleeve to engage the float, trapping the buffy coat constituents in the annular volume.

If desired, the flexible sleeve can be removed from the sample tube. The blood sample present in the annular volume can then be analyzed. Alternatively, at least one support member of the float can be welded to the flexible sleeve.

The compressible material can be water, a slurry, a gel, a foam, or an elastomer. Generally, the compressible material is fed into the sample tube in a volume such that the compressible material is at a level in the sample tube higher than a top end of the main body portion after centrifugation. Desirably, the compressible material has a viscosity low enough so as not to adhere to the flexible sleeve.

In other embodiments, a non-flexible metal sample tube is used. The blood sample and the float are introduced into a flexible sleeve, and the flexible sleeve is placed into the metal sample tube. After centrifugation, the metal sample tube is constricted to capture the float and trap buffy coat constituents in the annular volume.

A kit for separation of buffy coat constituents in a blood sample is also provided. The kit includes a metal sample tube, a flexible sleeve, and a float. The float has a specific gravity intermediate that of red blood cells and plasma. The float has a main body portion and one or more support members protruding from the main body portion.

Disclosed in other embodiments is a flexible volume-occupying separator float. The flexible float comprises a main body portion and one or more support members protruding from the main body portion. Prior to centrifugation, the float has a first cross-sectional diameter. The float is formed from a compressible material such that the float will shrink to a second cross-sectional diameter which is less than the first cross-sectional diameter upon application of a centrifugal force.

In use, the first cross-sectional diameter of the flexible float is sized to engage the sidewall of a sample tube. The sample tube may be flexible or rigid (i.e. non-flexible). The tube is then centrifuged at a rotational speed that causes the float to shrink to the second cross-sectional diameter, which is sufficiently small to permit movement of the float into alignment with at least the buffy coat constituents of the blood sample. Upon reducing the rotational speed, the float enlarges to the first cross-sectional diameter, trapping buffy coat constituents in the annular volume.

Other embodiments of a flexible volume-occupying separator float are also disclosed. There, the float comprises a main body portion made from a flexible sidewall. The flexible sidewall has a first edge and a second edge, the first and second edges overlapping to define an interior volume. The first edge comprises a detent and the second edge comprises a notch. A spring is located within the interior volume, the spring having a first end and a second end. The first end of the spring is attached to an interior surface, and the second and of the spring is attached to the second edge of the flexible sidewall. The spring compresses during centrifugation to reduce the diameter of the float. The detent engages the notch of the second edge when the spring expands after centrifugation.

In use, the spring compresses during centrifugation, reducing the diameter of the float. This shrinkage permits movement of the float into alignment with at least the buffy coat constituents of the blood sample. Upon reducing the rotational speed, the spring expands and the float returns to its original diameter, capturing the buffy coat constituents in the annular volume. The float may be used with a flexible or rigid sample tube.

Other designs for a flexible volume-occupying separator float are also disclosed. The float comprises an inner core, an outer sidewall, and at least one support member connecting the inner core to the outer sidewall. The inner core has atop end and a bottom end. The outer sidewall is formed from an optically clear material. Buffy coat materials become trapped between the inner core and the outer sidewall.

At least one high pressure seal may surround the outer sidewall if desired. In particular embodiments, a top high pressure seal is present around a top end of the outer sidewall, and a bottom high pressure seal is present around a bottom end of the outer sidewall.

The at least one support member may include a plurality of axial ridges that extend axially from the top end of the inner core to the bottom end of the inner core.

In some embodiments, the float also includes a bottom end cap for sealing a bottom end of the float, the bottom end cap having a diameter substantially equal to a diameter of the outer sidewall. The inner core may have an internal passage extending from the bottom end to the top end, so that a manipulator can extend through the internal passage to the bottom end cap for handling the bottom end cap. The bottom end of the inner core and the bottom end cap may comprise a mutual engagement system for connecting the bottom end cap to the inner core.

In other embodiments, the float can include a top and cap for sealing a top end of the float, the top end cap having a diameter substantially equal to a diameter of the outer sidewall. The top end of the inner core and the top end cap may comprise a mutual engagement system for connecting the top end cap to the inner core. The top end cap may have a member extending axially away from the float.

Sometimes, both a top end cap and a bottom end cap are used. In some of these embodiments, the top end cap member is hollow, and the bottom end cap manipulator extends through the top end cap member.

Generally, when the float is used, the buffy coat constituents of the blood sample become located in the annular volume between the outer sidewall and the inner core. The buffy coat constituents can be analyzed through the optically clear outer sidewall of the float.

Alternatively, the bottom end of the float can be sealed with the bottom and cap to capture the buffy coat constituents within the float. The top end of the float can also be sealed with the top end cap.

In some embodiments, the sample tube comprises one or more circumferential notches on the sidewall of the sample tube to facilitate the breaking of the tube at each notch. The sample tube may be broken at at least one of the one or more notches to obtain a broken section of the tube containing the float.

The one or more circumferential notches can be located on an exterior or interior surface of the sample tube. The one or more circumferential notches can be continuous around a circumference of the sample tube.

In particular embodiments, the circumferential notches comprise two sets of notches that divide the tube into three volumes. Desirably, one set of notches is above the float and one set of notches is below the float after reducing the rotational speed.

Notches can be broken above and below the float to remove the red blood cells and plasma, isolating the buffy coat materials in the float. Desirably, no broken notches are present along the axial length of the float.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a side view of a sample tube containing a volume-occupying separator float.

FIG. 2 is a diagram illustrating the methods of the present disclosure.

FIG. 3 is a side view of a sample tube containing a compressible material, a flexible sleeve, and a separator float.

FIG. 4 is a side view of a metal sample tube containing a flexible sleeve and a volume-occupying separator float therein.

FIG. 5 is a side view of a rigid sample tube containing a flexible or compressible separator float.

FIG. 6 is a top cross-sectional view of a flexible separator float formed from a flexible sidewall.

FIG. 7 is a side view of a notched sample tube containing a separator float having a top end cap and a bottom end cap.

FIG. 8 is a perspective view of the separator float of FIG. 7.

FIG. 9A is a perspective view of a continuous notch on a notched sample tube.

FIG. 9B is a perspective view of a discontinuous notch on a notched sample tube.

FIG. 9C is a side view of a rectangular notch on a notched sample tube.

FIG. 9D is a side view of a triangular notch on a notched sample tube.

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

The present disclosure relates generally to apparatuses and assemblies which are useful for separating, identifying, capturing, and/or quantifying the various components of a blood sample, based on the density of the various components. Those apparatuses include volume-occupying separator floats, sample tubes, and combinations thereof.

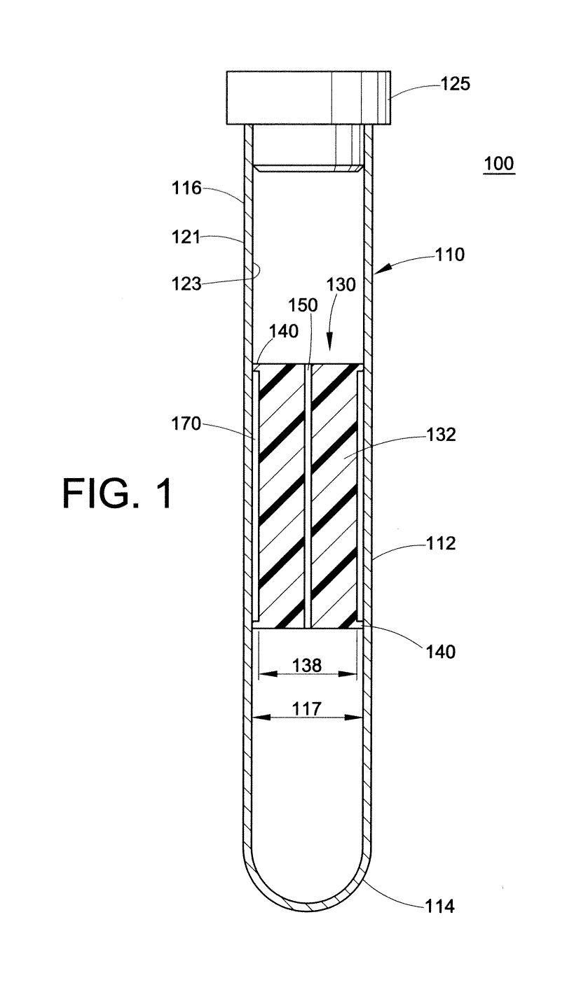

FIG. 1 is an axial cross-section of a blood separation tube and float assembly 100. The assembly includes a sample tube 110 and a separator float or bobber 130 placed therein.

The sample tube 110 is generally cylindrical. However, sample tubes having polygonal and other geometrical cross-sectional shapes are also contemplated. In other words, the sample tube may have a cross-section that is a polygon having n sides. For example, when n=3, the sample tube has a triangular cross-section. In particular, the sample tube may have a regular polygonal cross-section (i.e. the lengths of each side are substantially equal).

The sample tube 110 includes a first, closed end 114 and a second, open end 116 receiving a stopper or cap 119. Other closure means are also contemplated, such as parafilm or the like. In alternative embodiments, discussed further herein, the sample tube may be open at each end, with each end receiving an appropriate closure device.

Although the tube is depicted as generally cylindrical, the tube 110 may be minimally tapered, slightly enlarging toward the open end 116, particularly when manufactured by an injection molding process. This taper or draft angle is generally necessary for ease of removal of the tube from the injection molding tool.

The tube 110 is formed of a transparent or semi-transparent material and the sidewall 112 of the tube 110 is sufficiently flexible or deformable such that it expands in the radial direction during centrifugation, e.g., due to the resultant hydrostatic pressure of the sample under centrifugal load. As the centrifugal force is removed, the tube sidewall 112 substantially returns to its original size and shape. The sidewall 112 has an exterior surface 114 and an interior surface 116.

The tube may be formed of any transparent or semi-transparent, flexible polymeric material (organic and inorganic), such as polystyrene, polycarbonate, styrene-butadiene-styrene (“SBS”), styrene/butadiene copolymer (such as “K-Resin®” available from Phillips 66 Co., Bartlesville, Okla.), etc. Preferably, the tube material is transparent. However, the tube does not necessarily have to be clear, as long as the receiving instrument that is looking for the cells or items of interest in the sample specimen can “see” or detect those items in the tube. For example, items of very low level of radioactivity that cannot be detected in a bulk sample can be detected through a non-clear or semi-transparent wall after it is separated by the process of the present disclosure and trapped near the wall by the float 130 as described in more detail below. Desirably, the sample tube is seamless, at least along those portions of the tube along which the float will travel.

In some embodiments, the tube 110 is sized to accommodate the float 130 plus at least about five milliliters of blood or sample fluid, more preferably at least about eight milliliters of blood or fluid, and most preferably at least about ten milliliters of blood or fluid. In particular embodiments, the tube 110 has an inner diameter 121 of about 1.5 cm and accommodates at least about ten milliliters of blood in addition to the float 130.

The float 130 depicted here includes a main body portion 132 and two sealing rings or flanges 140, disposed at opposite axial ends of the float 130. The main body portion 132 and the sealing rings or support members 140 of the float 130 are sized to have an outer diameter which is less than the inner diameter 117 of the sample tube 110, under pressure or centrifugation. Put another way, the outer diameter of the support members is substantially equal to the inner diameter 117 of the sample tube 110 in a non-flexed state, so that the float can be held in a particular location by the sample tube. The main body portion 132 of the float 130 also has a smaller outer diameter 138 which is less than the diameter of the sealing or support rings 140, thereby defining an annular volume 170 between the float 130 and the sidewall 112 of the tube 110. The main body portion occupies much of the cross-sectional area of the tube, with the annular volume 170 being large enough to contain the cellular components of the buffy coat layers (i.e. buffy coat constituents) and associated target cells when the tube is in the non-flexed state. Preferably, the dimensions 138 and 117 are such that the annular volume 170 has a radial thickness ranging from about 25 microns to about 250 microns, most preferably about 50 microns. It should be noted that the term “annular” is used to refer to the ring-like shape formed by the float within the tube, and should not be construed as requiring the shape to be defined by two concentric circles. Rather, the tube and the float may each have different shapes and “annular” refers to the shape formed between them. The number of support members 140 may also vary, as will be seen further herein.

A bore or channel 150 extends axially through the float 130. When the tube/float system is centrifuged, the tube expands, freeing the float in the blood sample. As centrifugation is slowed, the float is captured by the sidewall 112 of the tube as the sube returns to its original diameter. As the tube continues to contract, pressure may build up in the blood fraction trapped below the float, primarily red blood cells. This pressure may cause red cells to be forced into the annular volume 170 containing the captured buffy coat constituents, thus diluting the contents or making imaging of the contents of the buffy coat more difficult. Alternatively, the collapse of the side wall of the sample tube during deceleration may produce excessive or disruptive fluid flow through the separated buffy coat layers. The bore 150 allows for any excessive fluid flow or any resultant pressure in the dense fractions trapped below the float 130 to be relieved. The excessive fluid flows into the bore 150, thus preventing degradation of the buffy coat sample. This bore can be considered a pressure relief means for inhibiting excessive fluid flow through the buffy coat constituents. The bore is depicted here as being central and axially aligned within the float 130, but other configurations are contemplated so long as the bore extends completely through the float from one end to the other. In some embodiments, the bore 150 is centrally located and axially extending.

While in some instances the outer diameter 138 of the main body portion 132 of the float 130 may be less than the inner diameter 117 of the tube 110, this relationship is not required. This is because once the tube 110 is centrifuged (or pressurized), the tube 110 expands and the float 130 moves freely. Once the centrifugation (or pressurization) step is completed, the tube 130 constricts back down on the sealing rings or support ridges 140 to capture the float. The annular volume 170 is then created, and sized by the length of the support ridges or sealing rings 140 (i.e., the depth of the “pool” is equal to the length of the support ridges 140, independent of what the tube diameter is/was).

In desired embodiments, the float dimensions are 3.5 cm tall×1.5 cm in diameter, with a main body portion sized to provide a 50-micron gap for capturing the buffy coat layers of the blood. Thus, the volume available for the capture of the buffy coat layer is approximately 0.08 milliliter. Since the entire buffy coat layer is generally less than about 0.5% of the total blood sample, the preferred float accommodates the entire quantity of buffy layer separated in an eight to ten milliliter sample of blood.

The sealing or support flanged ends 140 are sized to be substantially equal to, or slightly greater than, the inner diameter 117 of the tube. The float 130, being generally rigid, can also provide support to the flexible tube wall 112. Furthermore, the support members 140 provide a sealing function to maintain separation of the blood constituent layers. The seal formed between the support members 140 of the float and the wall 112 of the tube may form a fluid-tight seal. As used herein, the term “seal” is also intended to encompass near-zero clearance or slight interference between the flanges 140 and the tube wall 112 providing a substantial seal which is, in most cases, adequate for purposes of the disclosure.

The support members 140 are most preferably continuous ridges, in which case the sample may be centrifuged at lower speeds and slumping of the separated layers is inhibited. However, in alternative embodiments which are discussed further herein, the support members can be discontinuous or segmented bands having one or openings providing a fluid path in and out of the annular gap 190. The support members 140 may be separately formed and attached to the main body portion 132. Preferably, however, the support members 140 and the main body portion 132 form a unitary or integral structure.

The geometrical configuration of the support members are exemplary only, and different configurations are contemplated. For example, the support member 140 in FIG. 1 is flat but support members that are tapered away from the main body portion or concave curved are also contemplated. These shapes can provide a surface that encourages flow of the blood around the float during centrifugation. Additional exemplary shapes contemplated include, but are not limited to, tectiform and truncated tectiform; three, four, or more sided pyramidal and truncated pyramidal, ogival or truncated ogival; geodesic shapes, and the like.

The overall specific gravity of the separator float 130 should be between that of red blood cells (approximately 1.090) and that of plasma (approximately 1.028). In more specific embodiments, the specific gravity is in the range of from about 1.089 to about 1.029, more preferably from about 1.070 to about 1.040, and most preferably about 1.05.

The float may be formed of multiple materials having different specific gravities, so long as the overall specific gravity of the float is within the desired range. The overall specific gravity of the float 130 and the volume of the annular gap 190 may be selected so that some red cells and/or plasma may be retained within the annular gap, as well as the buffy coat layers. Upon centrifuging, the float 130 occupies the same axial position as the buffy coat layers and target cells and floats on the packed red cell layer. The buffy coat is retained in the narrow annular gap 190 between the float 130 and the inner wall 112 of the tube 110. The expanded buffy coat region can then be examined, under illumination and magnification, to identify circulating epithelial cancer or tumor cells or other target analytes.

In embodiments, the density of the float 130 is selected to settle in the granulocyte layer of the blood sample. The granulocytes settle on, or just above, the packed red-cell layer and have a specific gravity of about 1.08-1.09. In this preferred embodiment, the specific gravity of the float is in this range of from about 1.08 to about 1.09 such that, upon centrifugation, the float settles in the granulocyte layer. The amount of granulocytes can vary from patient to patient by as much as a factor of about twenty. Therefore, selecting the float density such that the float settles in the granulocyte layer is especially advantageous since loss of any of the lymphocyte/monocyte layer, which settles just above the granulocyte layer, is avoided. During centrifugation, as the granulocyte layer increases in size, the float settles higher in the granulocytes and keeps the lymphocytes and monocytes at essentially the same position with respect to the float. In other embodiments described further herein, the float may be made from two pieces, and the specific gravity of each piece may differ.

The float 130 is formed of one or more generally rigid organic or inorganic materials, preferably a rigid plastic material, such as polystyrene, acrylonitrile butadiene styrene (ABS) copolymers, aromatic polycarbonates, aromatic polyesters, carboxymethylcellulose, ethyl cellulose, ethylene vinyl acetate copolymers, nylon, polyacetals, polyacetates, polyacrylonitrile and other nitrile resins, polyacrylonitrile-vinyl chloride copolymer, polyamides, aromatic polyamides (aramids), polyamide-imide, polyarylates, polyarylene oxides, polyarylene sulfides, polyarylsulfones, polybenzimidazole, polybutylene terephthalate, polycarbonates, polyester, polyester imides, polyether sulfones, polyetherimides, polyetherketones, polyetheretherketones, polyethylene terephthalate, polyimides, polymethacrylate, polyolefins (e.g., polyethylene, polypropylene), polyallomers, polyoxadiazole, polyparaxylene, polyphenylene oxides (PPO), modified PPOs, polystyrene, polysulfone, fluorine containing polymer such as polytetrafluoroethylene, polyurethane, polyvinyl acetate, polyvinyl alcohol, polyvinyl halides such as polyvinyl chloride, polyvinyl chloride-vinyl acetate copolymer, polyvinyl pyrrolidone, polyvinylidene chloride, specialty polymers, and so forth, and most preferably polystyrene, polycarbonate, polypropylene, acrylonitrite butadiene-styrene copolymer (“ABS”) and others.

In this regard, it is desirable to avoid the use of materials and/or additives that interfere with the detection or scanning method. For example, if fluorescence is utilized for detection purposes, the material utilized to construct the float 130 should not have interfering or “background” fluorescence at the wavelength of interest.

In some aspects, the compressibility and/or rigidity of the flexible tube and rigid float can be reversed. The float is flexible and designed to shrink in diameter at the higher pressures and moves freely within a rigid or non-flexible sample tube. The use of a compressible float allows for usage of transparent glass tubes which, in some instances, exhibit enhanced optical properties over polymeric tubes. Furthermore, this aspect generally reduces the tolerance requirements for the glass tubes (since the float would expand up against the tube wall after the pressure decreases), and a full range of float designs is possible.

The method for detecting circulating epithelial cancer cells in a blood of a subject is disclosed in U.S. Pat. No. 6,197,523 may advantageously be modified to employ the sample tube and float system of the subject disclosure. The aforementioned U.S. Pat. No. 6,197,523 is incorporated herein by reference in its entirety.

In an exemplary method of using the tube/float system 100 of the disclosure, a sample of anticoagulated blood is provided. For example, the blood to be analyzed may be drawn using a standard Vacutainer® or other like blood collection device of a type having an anticoagulant predisposed therein. Alternatively, a flexible sample tube may be used to directly capture the blood to be analyzed.

A tag, such as a fluorescently labeled antibody or ligand, which is specific to the target epithelial cells or other target analytes of interest, can be added to the blood sample and incubated prior to centrifugation. In an exemplary embodiment, the epithelial cells are labeled with anti-epcam having a fluorescent tag attached to it. Anti-epcam binds to an epithelial cell-specific site that is not expected to be present in any other cell normally found in the blood stream. A stain or colorant, such as acridine orange, may also be added to the sample to cause the various cell types to assume differential coloration for ease of discerning the buffy coat layers under illumination and to highlight or clarify the morphology of epithelial cells during examination of the sample.

The blood is then transferred to the assembly 100 for centrifugation. The float 130 may be introduced into the tube 110 after the blood sample is introduced into the sample tube 110 or otherwise may be placed therein beforehand. The tube and float assembly 100 containing the sample is then centrifuged. Operations required for centrifuging the blood by means of the subject tube/float system 100 are not expressly different from the conventional case, although, as stated above, reduced centrifuge speeds may be possible and problems of slumping may be reduced. An adaptor may optionally be utilized in the rotor to prevent failure of the flexible tube due to stress.

During centrifugation, the sample tube is spun at a rotational speed sufficient to cause several effects. In particular, the resultant hydrostatic pressure deforms or flexes the wall 112 so as to enlarge the diameter of the tube from a first cross-sectional inner diameter to a second diameter, the second diameter being greater than the first diameter. The second diameter is sufficiently large to permit the blood components and the float 130 to move axially under centrifugal force within the tube 110. The blood sample is separated into six discrete and distinct layers according to density, which are, from bottom to top (most dense to least dense): packed red blood cells, reticulocytes, granulocytes, lymphocytes/monocytes, platelets, and plasma. The epithelial cells sought to be imaged tend to collect by density in the buffy coat layers, i.e., in the granulocyte, lymphocyte/monocyte, and platelet layers. Due to the density of the float, the float occupies the same axial position within the sample tube as the buffy coat layers/constituents which thus occupy the narrow annular volume 190, potentially along with a small amount of the red cell and/or plasma). Put another way, the float moves into alignment with at least the buffy coat constituents of the blood sample.

After centrifugal separation is complete and the centrifugal force is removed, the tube 110 returns to its original diameter to capture or retain the float and the buffy coat layers and target analytes within the annular volume 190. The tube/float system can be transferred to a microscope or optical reader to identify any target analytes in the blood sample. Depending on the subsequent use of the float, the annular volume may be considered to make up one or more analysis areas.

Centrifugation may not be required. Sometimes the application of pressure alone to the inside of the tube, or simply the expansion of the tube (or the compression of the float) is required. For example, such pressure can be produced through the use of a vacuum source on the outside of the tube. Such an application also allows for the top of the sample tube to be kept open and easily accessible. Additionally, the use of a vacuum source may be easier to implement in some situations than the application of a centrifugal force. Additionally, any method of tubular expansion/contraction (or float compression) such as mechanical, electrical, magnetic, etc., can be implemented. Once the tube is expanded (or the float is compressed), the float will move to the proper location due to buoyancy forces created by the density variations within the sample.

In additional embodiments described herein, a removal device, such as a syringe, is then used to extract the buffy coat layers/constituents from the annular volume. The intent here is to extract the target cells of interest, no it is acceptable to remove some of the red blood cells and/or plasma during this process as well. If tags have not yet been added, they may be added now to tag or label the “target” cells of interest. Again, the tags are any kind that an analytical instrument or detector could detect, e.g. fluorescent, radioactive, etc. The tags may be in the removal device itself, or they can be added separately.

The sample is then applied, such as by being “squirted”, through the instrument/detector and the tagged cells are analyzed. It may be sufficient to count the number of tagged cells. However, in further embodiments, the ‘positive’ sample cells are diverted into a holder for further analysis. Means of separating such cells are known in the art and can be similar to those used in flow cytometry, for example by coordinating the timing of the instrument/detector with the holder. The positive sample can then be further analyzed, for example by preparing a slide for further examination. This ‘squirt-n-divert’ method results in a smaller sample volume that is easier to analyze compared to the original blood sample, which was many times larger.

The float can comprise a part of a collection tube system or assembly. Thus, it is not necessary to transfer the buffy coat sample from a collection container to an analysis tube. The blood or sample fluid can be collected immediately and then tested. Such a system is somewhat faster, and also safer from a biohazard standpoint. For example, this system is desirable in very contagious situations (i.e. Ebola virus, HIV, etc.) where any type of exposure of the blood must be minimized.

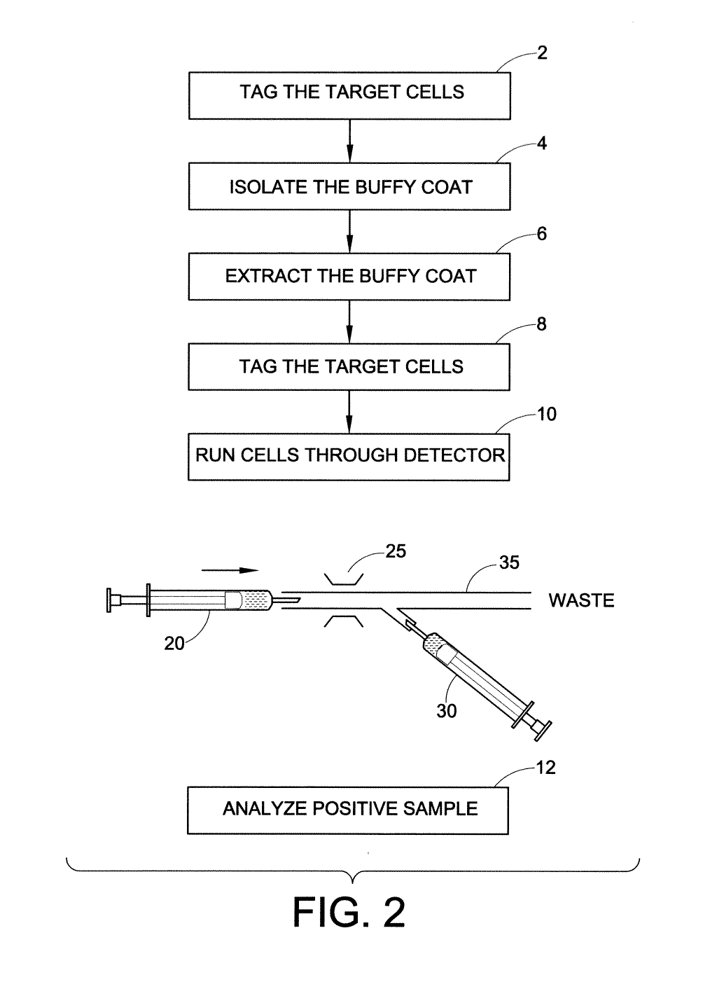

FIG. 2 is a diagram illustrating some of the general methods described above. In step 2, the target cells in the buffy coat layers of the blood sample can be tagged prior to centrifugation. In step 4, the buffy coat is isolated, e.g. by centrifugation. In step 6, the sample containing the buffy coat, and reduced in volume compared to the original blood sample, is extracted from the sample tube. In step 8, if the target cells were not already tagged, they can be tagged now. Alternatively, they can be tagged using different tags suitable for use with the given instrument/detector. In step 10, the reduced volume is run through the detector. As illustrated here, the reduced volume with the tagged target cells begin in syringe 20 and are injected into detector 25 which separates the ‘positive’ sample (i.e. target cells) and diverts them into holder 30. The ‘negative’ sample goes to waste 35, i.e. is disposed of. Finally, in step 12, the positive sample is further analyzed.

The sample tubes, separator floats, and methods described above provide a general idea of the present disclosure. Several further concepts are described herein.

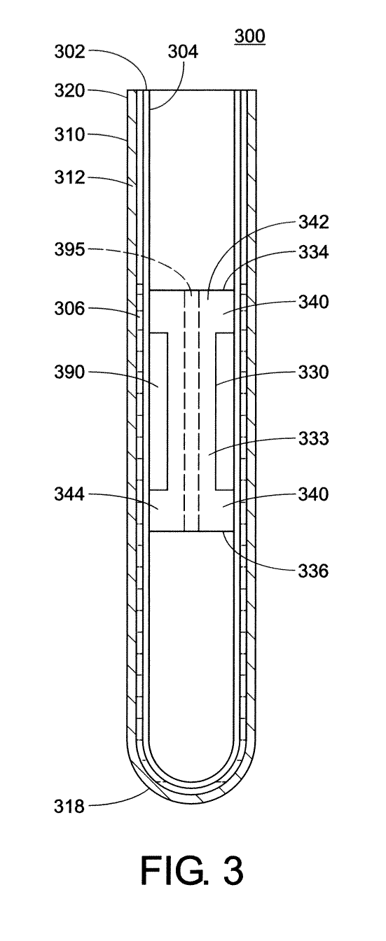

FIG. 3 shows a concept of a blood separation apparatus 300 including a sample tube 310, a flexible sleeve 302, a separator float 330, and a compressible material 306 placed between the flexible sleeve 302 and sample tube 310. The sample tube 310 includes a sidewall 312, a first, closed end 318, and a second, open end 320. The flexible sleeve 302 includes an inner surface 304 and may be formed of a transparent or semi-transparent material.

The separator float 330 includes a main body portion 333 having a top end 334 and a bottom end 336. One or more support members 340 protrude, or extend radially, from the main body portion 333. The support members 340 may include a top support member 342 extending radially from the top end 334 and a bottom support member 344 extending radially from the bottom end 336. A pressure relief means, such as an axial bore 395, can extend from the top end 334 through the bottom end 336 to relieve excessive pressure below the float. The main body portion 333 and the inner surface 304 of the flexible sleeve 302 define an annular volume 390.

Prior to centrifugation, the compressible material 306 is between the flexible sleeve 302 and sample tube 310. The compressible material applies pressure to the sleeve, causing the inner surface 304 of the flexible sleeve 302 to engage the float 330. The compressible material is usually present in a volume such that the level of the compressible material is above the level of the float, prior to centrifugation. The compressible material 306 may be water, a slurry, a gel, a foam, or an elastomer. Desirably, the compressible material has a viscosity low enough so that it does not adhere to the sleeve 302.

Prior to centrifugation, the blood sample and the float 330 are introduced into the flexible sleeve 302; the compressible material 306 is fed to the sample tube 310; and the flexible sleeve 302 is placed into the sample tube 310. The steps of introducing the sample to the sleeve 302, introducing the float 330 to the sleeve 302, feeding compressible material 306 to the sample tube 310, and placing the sleeve 302 into the sample tube 310 can generally be performed in any order. However, the blood sample and the float are generally introduced into the flexible sleeve prior to placing the flexible sleeve into the sample tube.

During centrifugation, the compressible material 306 is compressed or moved, so that the pressure on the flexible sleeve 302 is reduced. This reduction releases the float 330, allowing the float to align with the buffy coat constituents. When the rotational speed is reduced, the compressible material 306 returns to its original position or shape, thus applying pressure again and causing the flexible sleeve 302 to engage the float 330 and trap the buffy coat constituents in the annular volume 390. The flexible sleeve 302 can then be removed from the sample tube 310 and the blood sample present in the annular volume 390 can be analyzed. In this regard, desirably the compressible material has a low viscosity, so that the compressible material can drip or otherwise easily be removed from the flexible sleeve to prevent any difficulties in analyzing the blood sample.

In some embodiments, at least one support member 340 is welded to the flexible sleeve 302. In particular embodiments, a top support member and a bottom support member are welded to the flexible sleeve. The welding may be performed ultrasonically (i.e. by ultrasonic welding). Again, the compressible material 306 is generally fed into the sample tube 310 in a volume such that the compressible material 306 is at a level in the sample tube 310 higher than the top end 334 or the main body portion 333 of the float 330 after centrifugation.

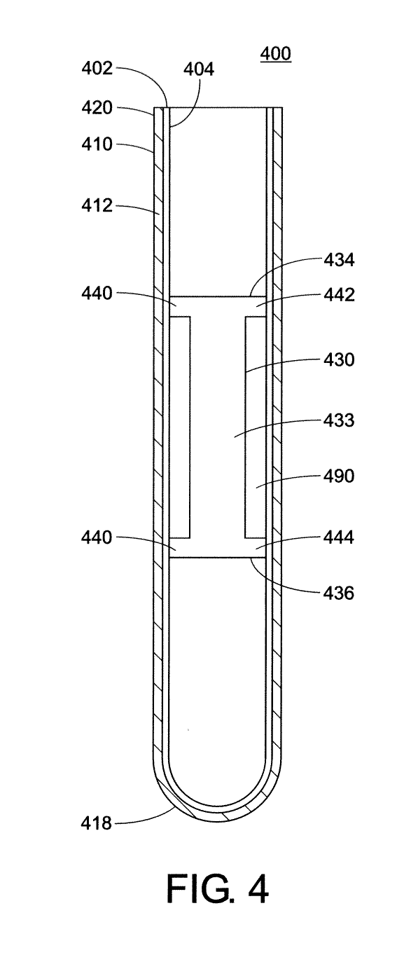

FIG. 4 shows another concept of an apparatus 400 for separating blood samples. The apparatus 400 includes a metal sample tube 410, a flexible sleeve 402, and a separator float 430. The sample tube 410 includes a sidewall 412, a first, closed end 418, and a second, open end 420. The flexible sleeve 402 includes an inner surface 404 and may be formed of a transparent or semi-transparent material.

The separator float 430 includes a main body portion 433 having a top end 434 and a bottom end 436. One or more support members 440 protrude, or extend radially from the main body portion 433. The support members 440 may include a top support member 442 extending radially from the top end 434 and a bottom support member 444 extending radially from the bottom end 436. A pressure relief means may be present, such as an axial bore (not shown) extending from the top end 434 through the bottom end 436. The main body portion 433 and the inner surface 404 of the flexible sleeve 402 define an annular volume 490.

This apparatus is used as generally described above, with the blood sample and the float being introduced into the flexible sleeve, the flexible sleeve being placed into the metal sample tube, and centrifugation being applied to align the float (and the annular volume 490) with the buffy coat constituents. As centrifugation ends and the rotational speed is being reduced, here, the metal tube 410 is constricted or crushed. This causes the metal tube to capture the sleeve 402 and the float 430, trapping the buffy coat constituents in the annular volume 490. The tube 410 may be constricted before, during, or after the reduction of the rotational speed.

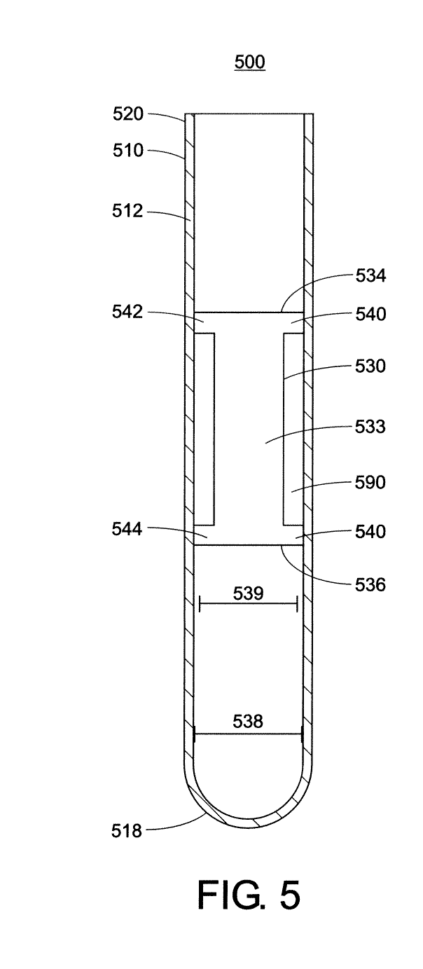

FIG. 5 illustrates an apparatus 500 where the separator float 530 is flexible, instead of the sample tube. The sample tube 510 includes a sidewall 512, a first, closed end 518, and a second, open end 520. The sidewall of the sample tube can be rigid or flexible.

The separator float 530 includes a main body portion 533 having a top end 534 and a bottom end 536. One or more support members 540 protrude, or extend radially, from the main body portion 533. The support members 540 may include a top support member 542 extending radially from the top end 534 and a bottom support member 544 extending radially from the bottom end 536. The main body portion 533 and the sidewall 512 of the sample tube 510 together define an annular volume 590. The float 530 optionally includes a pressure relief means, such as an axial bore (not shown).

When the float is not under centrifugal pressure, the float 530 has a first cross-sectional diameter 538. However, during centrifugation, the diameter of the float 530 shrinks to a second cross-sectional diameter 539 which is less than the first cross-sectional diameter 538 due to the centrifugal force. The second cross-sectional diameter 539 is sufficiently small that the float can move within the sample tube 510. This change in diameter permits the float 530 to align with the buffy coat constituents. The centrifugal force is dependent upon the pressure created during centrifugation—the lower the speed, the lower the centrifugal force generated. The float is generally designed to collapse at a relatively low force, and the degree to which the diameter decreases should be limited. When the rotational speed is reduced, the float 530 enlarges to the first cross-sectional diameter 538, trapping the buffy coat constituents in the annular volume 590.

The flexible float 530 includes flexible and/or compressible materials. However, the entire float does not need to be made of such materials. For example, the main body portion 533 may be made from rigid materials, while the support members 540 are made from a compressible material, or vice versa. In some embodiments, however, the main body portion 533 and the support members 540 are made from compressible materials. Suitable flexible and/or compressible materials may include flexible polymers. Exemplary flexible polymers includes urethane, rubber, and silicone polymers.

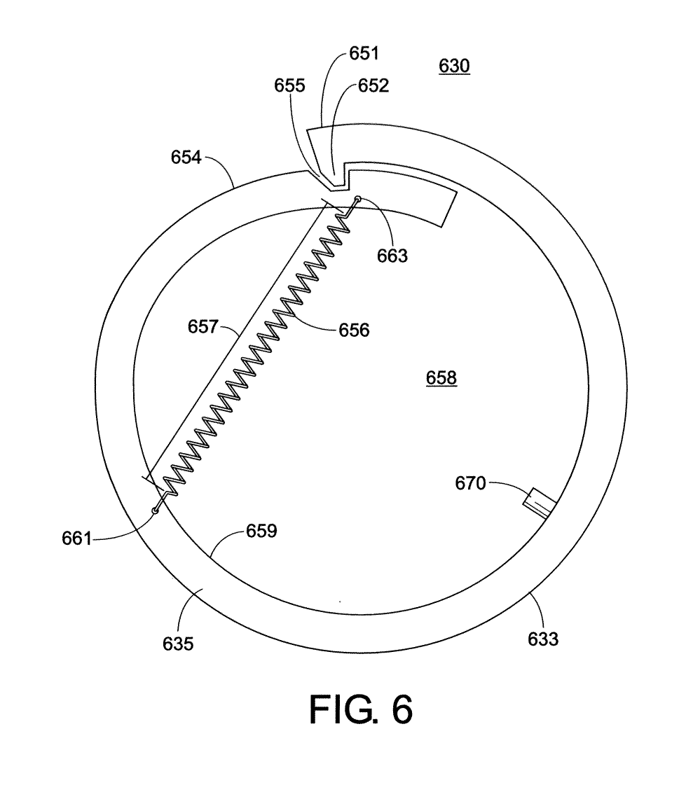

FIG. 6 shows a top, cross-sectional view of another embodiment of a flexible separator float 630. The separator float 630 includes a main body portion 633 which is formed from a flexible sidewall 635. The flexible sidewall 635 has a first edge 651 and a second edge 654. The term “edge” is used here to refer to an area or volume along one side of the sidewall, and not in the mathematical sense of a one-dimensional line. The first edge 651 and second edge 654 overlap to define an interior volume 658. An interior surface 659 is present within the interior volume 658.

A detent 652 is present along the first edge 651. The detent 652 engages a notch 655 which is present along the second edge 654. A spring 656 is also present within the interior volume 658. The spring has a first end 661 and a second end 663. The first end 661 of the spring is attached to the interior surface 659 and the second end 663 of the spring is attached to the second edge 654 of the flexible sidewall 635. Put another way, the spring 656 connects the interior surface 659 to the second edge 654. The spring 656 is constructed so that at rest, the spring has a given length 657 and can be compressed to a shorter length. The flexible sidewall 635 may be considered as a sheet that is under some tension and desires to unfold/unroll itself. This bias ensures that the detent 652 engages the notch 655 as a default position. It should be noted that FIG. 6 is a cross-sectional view. The flexible sidewall 635 may be made so that the detent 652 and notch 655 are along the entire axial length, or along only a portion of the axial length of the sidewall 635. There may be more than one spring present as well.

In some embodiments, the float 630 may further include one or more support members protruding radially from the main body portion 633 and engaging the sidewall of the sample tube 610. In particular embodiments, a top support member (not visible) protrudes from the top end 634 and a bottom support member (not visible) protrudes from the bottom end (not visible) of the main body portion 633. The main body portion 633, support members 640, and tube sidewall define an annular volume 690. The two ends of the float are sealed and will also reduce in diameter, for example by flexing of the float. In particular embodiments, it is contemplated that the top end and the bottom end of the float are formed from a surface that has a conical shape, the base of the cone forming the top end or bottom end, and the apex of the cone being contained inside the float.

Prior to centrifugation, the detent 652 on the first edge 651 engages a notch 655 which is present along the second edge 654. When engaged, the flexible sidewall is prevented from further expansion. During centrifugation, the spring 656 is compressed by the centrifugal force. As the spring shortens, the spring pulls the second edge 654. This pulling action detaches the detent 652 from the notch 655, permitting the detent to travel along the sidewall 635, thereby reducing the diameter of the float 630. The reduction in diameter permits the float 630 to move into alignment with the buffy coat constituents. If desired, a stop 670 may be present to limit the travel of the second edge 654 and prevent the float from being damaged due to overstressing the flexible sidewall 635 during centrifugation. When the rotational speed is reduced, the spring 656 expands and the diameter of the float 630 increases until the detent 652 again engages the notch 655. The expansion of the float traps the buffy coat constituents in the annular volume 690.

It is also contemplated that the float could be placed into the sample tube in its reduced diameter. Centrifugation releases the detent, but the centrifugal force keeps the diameter of the float in its reduced state, i.e. smaller than the internal diameter of the sample tube due to the centrifugal force. After centrifugation ends, the diameter of the float would then expand up to the internal diameter of the tube. Again, the sample tube may be either rigid or flexible.

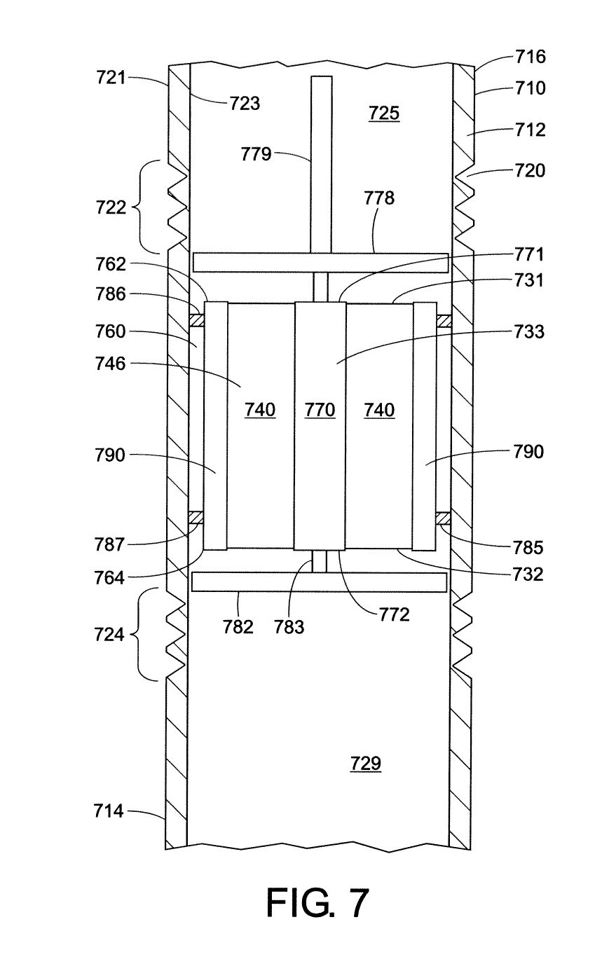

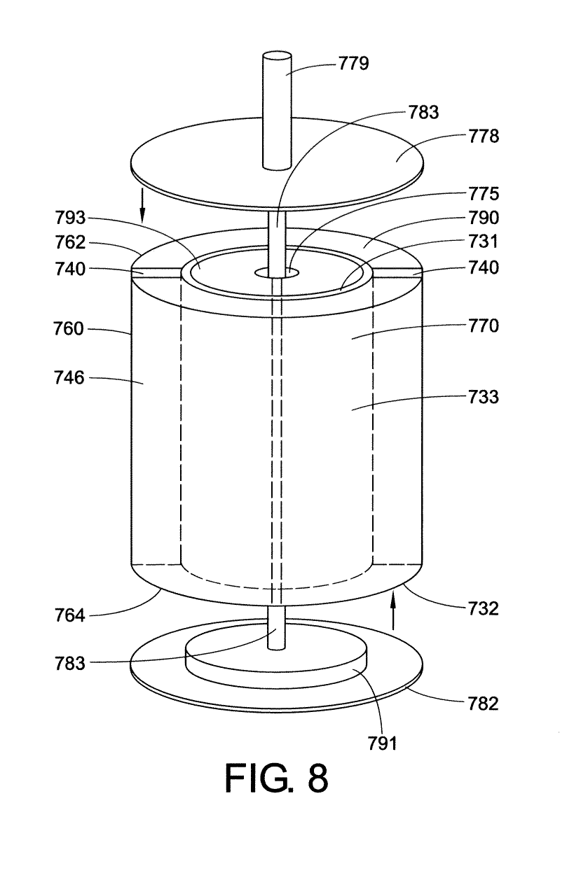

FIG. 7 and FIG. 8 illustrate another concept for a sample tube 710 and separator float 730. FIG. 7 is a side view, while FIG. 8 is a perspective view. The sample tube 710 includes a sidewall 712, a first, closed end 714 (closed portion not shown), and a second, open end 716.

The main body portion 733 of the separator float 730 has a top and 731 and a bottom end 732. The main body portion is constructed from an inner core 770 and an optically clear outer sidewall 760. The inner core 770 has a top end 771 and a bottom end 772. The optically clear outer sidewall 760 also has a top end 762 and a bottom end 764. It is contemplated that the inner core 770 and the outer sidewall 760 generally have the same axial length, as shown in FIG. 8. However, in some embodiments, as depicted in FIG. 7, the inner core 770 has a longer length than the outer sidewall 760, i.e. the inner core 770 is longer than the outer sidewall 760.

At least one support member 740 extends radially and connects the inner core 770 to the outer sidewall 760. Three support members are visible in FIG. 8. As shown there, the support members may comprise a plurality of axial ridges 746 extending axially from the top and 771 to the bottom end 772 of the inner core 770. An annular volume 790 is defined between the inner core 770 and the outer sidewall 760.

In some embodiments, at least one high pressure seal 785 surrounds the outer sidewall 760. As shown here, atop high pressure seal 786 is present around the top end 762 of the outer sidewall 760 and a bottom low pressure seal 787 is present around the bottom end 764 of the outer sidewall 760. The pressure seal(s) effectively prevent(s) fluid flow between the outer sidewall 760 and the sidewall 712 of the sample tube. An optional pressure relief passage (not shown) may extend axially from the top end 771 of the inner core 770 to the bottom end 772.

The separator float 730 is used as generally described above. In particular, when the main body portion 733 is captured after centrifugation, buffy coat constituents reside in the annular volume 790. The buffy coat constituents may then be analyzed through the optically clear outer sidewall 760.

The outer sidewall may be considered “optically clear” if images of the cells in the buffy coat constituents can be taken through the sidewall. In some embodiments, the outer sidewall has a transparency (% T) of more than 90%, or a haze level of 5% or below, when measured according to ASTM D1003.

It may be desirable to be able to retrieve the buffy coat constituents from the sample tube. In some embodiments, the float 730 may further comprise a bottom end cap 782 used for sealing the bottom end 732 of the float 730. The bottom end cap 782 may have a diameter substantially equal to the diameter of the outer sidewall 760. The bottom end cap 782 and bottom end 772 of the inner core 770 may comprise a mutual engagement system for connecting the bottom end cap 782 to the inner core 770. Suitable engagement systems include tongue-and-groove, detent-and-catch, hook-and-loop, etc. Alternatively, the cap could be welded to the bottom end 764 of the outer sidewall 760.

Similarly, the float 730 may also further comprise a top end cap 778 for sealing the top end 731 of the float 730. The top end cap 778 may have a diameter substantially equal to the diameter of the outer sidewall 760. The top end cap 778 and top end 771 of the inner core 770 may comprise a mutual engagement system for connecting the top end cap 778 to the inner core 770.

In FIG. 8, the bottom end cap 782 is shown as having a tongue 791 that can be inserted into a groove (not visible), and the top end cap 778 has a tongue (not visible) that can be inserted into a groove 793 in the top end 771 of the inner core 770. This illustrates one type of mutual engagement system which could be used for sealing the float. The top end cap could also be welded to the top end 762 of the outer sidewall 760. In particular embodiments, the float comprises both the bottom end cap and the top end cap.

The top end cap 778 generally comprises a top end cap member or handle 779 extending axially away from the float 730. The bottom end cap 782 also generally comprises a bottom end cap manipulator or handle 783 extending axially through an internal passage 775 in the inner core 770. The internal passage 775 extends from the bottom end 772 through the top end 771. In some embodiments, the top end cap member 779 is hollow and the bottom end cap manipulator 783 extends therethrough. The handles 779, 783 may be integral to the respective caps, or separate pieces that can be engaged with their respective cap after centrifugation ends. Pushing the top end cap member 779 engages the top end cap 778 with the top end 771 of the inner core. Pulling the bottom end cap manipulator 783 engages the bottom end cap 782 with the bottom end 772 of the inner core.

When the bottom end cap or top end cap are used with the float 730, they should be inserted into the sample tube 710 so that the bottom end cap 782 is closer to the first end 714 of the sample tube than the main body portion 733 and the top end cap 778 is closer to the second end 716 of the sample tube than the main body portion 733. The caps should not hinder flow through the main body portion 733 during centrifugation. This goal can be achieved by making the bottom end cap 782 slightly denser than the main body portion 733, and by making the top end cap 778 slightly less dense than the main body portion 733. In embodiments, the bottom end cap 782 has a specific gravity of greater than about 1.09. In embodiments, the top end cap 778 has a specific gravity of less than about 1.08. However, the caps should not become located too far away from the main body portion 733 because any volume between a cap and the main body portion at the end of centrifugation may also become sealed in the annular volume 790, which would increase the pressure therein and possibly cause one of the caps to fail.

The float 730 is desirably used in combination with a sample tube 710 from which the float can be extracted or removed. The sample tube 710 includes a sidewall 712, a first, closed end 714, a second, open end 716, and circumferential notches 720. A circumferential notch is formed by one or more grooves that lie substantially within the same plane, that plane being perpendicular to the sidewall of the tube. A first set 722 of notches is located above the float 730 and a second set 724 of notches is located below the float. Each set is shown here in FIG. 7 with three notches, but this number can vary and is generally between one and four notches in each set. The sample tube is broken along one or more notches to get access to the float and the buffy coat layers trapped in the annular volume 790.

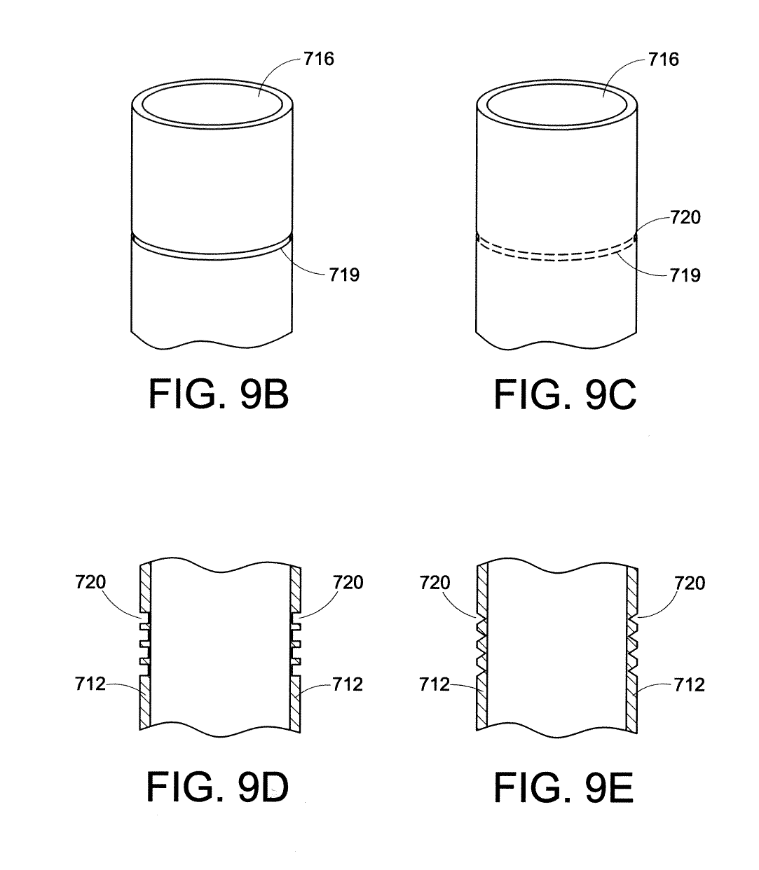

FIGS. 9A-9D illustrate different variations of the notches. In FIG. 9A, the depicted set has one notch which is formed by one continuous groove 719, i.e. the notch is continuous around the circumference. In FIG. 9B, the depicted notch is formed by a set of short grooves 719, i.e. the notch is discontinuous around the circumference. In FIG. 9C, the set has two notches, each of which is rectangularly shaped, while in FIG. 9D, the notch is triangularly shaped. In other words, the notch may have a triangular or rectangular axial cross-section. Other notch shapes, such as U-shaped, are also contemplated. These forms may be useful in directing how the tube breaks. Although the notches 720 in FIG. 7 are on the exterior surface 721 of the sample tube 710, the notches could be located on the interior surface 723 of the sample tube 710 and should not interfere with axial movement of the float. The sample tube may only have a single notch in some embodiments. However, in desirable embodiments, the sample tube 710 comprises a first set 722 of notches and a second set 724 of notches, which divide the tube into three volumes 725, 727, 729.

Again, the blood sample and float are introduced into the sample tube 710, the tube is centrifuged, and the rotational speed is then reduced to trap the buffy coat constituents in the annular volume. Methods using the sample tube 710 further include breaking the sample tube 710 at at least one of the one or more notches 720 to obtain a section of the tube 710 containing the float 730 and annular volume 790 which contains the buffy coat constituents. In certain preferred embodiments, at least one notch in the first set 722 of notches above the float 730 and at least one notch in the second set 724 of notches below the float 730 are broken. The tube may be broken, for example, by simple twisting or snapping. The annular volume 790 can be examined to identify target cells either before or after breaking the tube, as desired. Alternatively, breaking the tube makes it easier to remove the caps 782, 778 from the float 730 to obtain the desired buffy coat constituents.

Desirably, the amount of blood introduced into the sample tube is controlled so that after centrifugation, the float 730 is located in the middle volume 725 of the tube 710. As seen in FIG. 7, no notches are present along the axial length 731 of the float. This result aids in ensuring that breakage and consequent loss of the buffy coat layers does not occur.

Sealing glass ampules are known that allow the lower bulb, containing a sample, to be sealed off. Typically, such ampules have a constriction to which heat is applied to soften the glass. The glass collapses, forming the seal, and the lower bulb is gently pulled away from the remainder of the tube. Such sealed ampules differ from the sample tube of FIG. 7 in that the glass material of the tube completely surrounds the sample, whereas here the separator float itself provides one or two surfaces that surround the buffy coat sample. In addition, such sealed ampules typically seal their sample in the lower bulb, i.e. the ampule is divided into two volumes. In contrast, the sample tube of FIG. 7 can be divided into three volumes. Finally, the breaking of the sample tube is easier and less time-consuming than heating and sealing the ampule.

While particular embodiments have been described, alternatives, modifications, variations, improvements, and substantial equivalents that are or may be presently unforeseen may arise to applicants or other skilled in the art. Accordingly, the appended claims as filed and as they are amended are intended to embrace all such alternatives, modifications, variations, improvements, and substantial equivalents.

1. A method of separating and axially expanding buffy coat constitutents in a blood sample, comprising:
introducing the blood sample into a flexible sleeve;
introducing a volume-occupying float into the flexible sleeve, the float having a specific gravity intermediate that of red blood cells and plasma, and the float comprising:
a main body portion spacedly surrounded by an inner surface of the flexible sleeve to form an annular volume therebetween; and
one or more support members protruding from the main body portion;
feeding a compressible material into a sample tube;
placing the flexible sleeve into the sample tube, so that the compressible material is between the sample tube and the flexible sleeve, and the compressible material applies pressure sufficient to cause the flexible sleeve to engage the float;
centrifuging the sample tube at a rotational speed sufficient to reduce the pressure of the compressible material against the flexible sleeve, separate the blood into discrete layers, and permit movement of the float into alignment with at least the buffy coat constituents of the blood sample; and
reducing the rotational speed to cause the compressible material to apply pressure that causes the flexible sleeve to engage the float, trapping the buffy coat constituents in the annular volume.

2. The method of claim 1, wherein the compressible material is water, a slurry, a gel, a foam, or an elastomer.

3. The method of claim 1, further comprising:
removing the flexible sleeve from the sample tube; and
analyzing the blood sample present in the annular volume.

4. The method of claim 1, wherein the flexible sleeve is formed of a semi-transparent polymeric material.

5. The method of claim 1, wherein the flexible sleeve is formed of a transparent polymeric material.

6. The method of claim 1, further comprising welding at least one support member to the flexible sleeve.

7. The method of claim 6, wherein the float comprises a top support member protruding from a top end of the main body portion and a bottom support member protruding from a bottom end of the main body portion, and wherein the top and bottom support members are welded to the flexible sleeve.

8. The method of claim 6, wherein the welding is performed ultrasonically.

9. The method of claim 1, wherein the float further comprises a pressure relief means for inhibiting excessive fluid flow through the buffy coat constituents.

10. The method of claim 1, wherein the compressible material is fed into the sample tube in a volume such that the compressible material is at a level in the sample tube higher than a top end of the main body portion after centrifugation.

11. The method of claim 1, wherein the compressible material has a viscosity low enough so as not to adhere to the flexible sleeve.

12. The method of claim 1, wherein the flexible sleeve is placed into the sample tube prior to feeding the compressible material into a sample tube.

13. The method of claim 1, wherein the flexible sleeve is placed into the sample tube after feeding the compressible material into a sample tube.

14. The method of claim 1, wherein the steps of introducing the blood sample into the flexible sleeve, introducing the volume-occupying float into the flexible sleeve, feeding the compressible material into the sample tube, and placing the flexible sleeve into the sample tube can be performed in any order.

15. A method of separating and axially expanding buffy coat constitutents in a blood sample, comprising:
introducing the blood sample into a flexible sleeve;
introducing a volume-occupying float into the flexible sleeve, the float having a specific gravity intermediate that of red blood cells and plasma, and the float comprising:
a main body portion spacedly surrounded by an inner surface of the flexible sleeve to form an annular volume therebetween; and
one or more support members protruding from the main body portion;
wherein the support members engage the flexible sleeve;
placing the flexible sleeve into a metal sample tube;
centrifuging the sample tube at a rotational speed that causes enlargement of the flexible sleeve to a diameter sufficiently large to permit axial movement of the float, separation of the blood into discrete layers, and movement of the float into alignment with at least the buffy coat constituents of the blood sample;
reducing the rotational speed; and
constricting the metal sample tube to capture the float and trap buffy coat constituents in the annular volume.

16. The method of claim 15, wherein the metal sample tube is constricted after reducing the rotational speed.

17. The method of claim 15, wherein the metal sample tube is constricted prior to reducing the rotational speed.

18. A kit for separation of buffy coat constituents in a blood sample, comprising:
a metal sample tube;
a flexible sleeve; and
a float having a specific gravity intermediate that of red blood cells and plasma, and comprising;
a main body portion; and
one or more support members protruding from the main body portion.

19. A flexible volume-occupying separator float, comprising;
a main body portion; and
one or more support members protruding from the main body portion;
wherein the float has a first cross-sectional diameter; and
wherein the float is formed from a compressible material such that the float will shrink to a second cross-sectional diameter which is less than the first cross-sectional diameter upon application of a centrifugal force.

20. The float of claim 19, wherein the one or more support members include:
a top support member protruding from a top end of the main body portion; and
a bottom support member protruding from a bottom end of the main body portion.

21. The float of claim 19, wherein the float further comprises a pressure relief means for inhibiting excessive fluid flow through the buffy coat constituents.

22. The float of claim 19, wherein the compressible material is a flexible polymer.

23. The float of claim 19, wherein the float has a specific gravity of from about 1.08 to about 1.09.

24. A method of separating and axially expanding buffy coat constitutents in a blood sample, comprising:
introducing the blood sample into a sample tube, the sample tube having a sidewall;
introducing a flexible volume-occupying float into the sample tube, the float having a specific gravity intermediate that of red blood cells and plasma, and the float comprising:
a main body portion spacedly surrounded by an inner surface of the sample tube to form an annular volume therebetween; and
one or more support members protruding from the main body portion;
wherein the support members engage the sample tube and the float has a first cross-sectional diameter;
centrifuging the sample tube at a rotational speed that causes separation of the blood into discrete layers and shrinkage of the float to a second cross-sectional diameter which is sufficiently small to permit movement of the float into alignment with at least the buffy coat constituents of the blood sample;
reducing the rotational speed to cause the float to enlarge to the first cross-sectional diameter and trap buffy coat constituents in the annular volume.

25. The method of claim 24, wherein the sample tube is a rigid sample tube.

26. The method of claim 24, wherein the sample tube is a flexible sample tube.

27. A flexible volume-occupying separator float, comprising:
a main body portion comprising a flexible sidewall having a first edge and a second edge, the first and second edges overlapping to define an interior volume;
the first edge comprising a detent and the second edge comprising a notch; and
a spring located within the interior volume, the spring having a first end and a second end, the first end being attached to an interior surface and the second end being attached to the second edge of the flexible sidewall;
whereby the spring compresses during centrifugation to reduce the diameter of the float and the detent engages the notch of the second edge when the spring expands.

28. The float of claim 27, further comprising one or more support members protruding from the flexible sidewall.

29. The float of claim 28, wherein the one or more support members include:
a top support member protruding from a top end of the main body portion; and
a bottom support member protruding from a bottom end of the main body portion.

30. A method of separating and axially expanding buffy coat constitutents in a blood sample, comprising:
introducing the blood sample into a sample tube, the sample tube having a sidewall;
introducing a flexible volume-occupying float having a specific gravity intermediate that of red blood cells and plasma to the sample tube, said float comprising:
a main body portion comprising a flexible sidewall having a first edge and a second edge, the first and second edges overlapping to define an interior volume;
the first edge comprising a detent and the second edge comprising a notch; and
a spring located within the interior volume, the spring having a first end and a second end, the first end being attached to an interior surface and the second end being attached to the second edge of the flexible sidewall;
whereby the spring compresses during centrifugation to reduce the diameter of the float and the detent engages the notch of the second edge when the spring expands; and
one or more support members protruding from the main body portion and engaging the sidewall of the sample tube;
wherein the main body portion and the one or more support members define an annular volume;
centrifuging the sample tube at a rotational speed that causes the spring to compress and reduce the diameter of the float, permitting separation of the blood into discrete layers and movement of the float into alignment with at least the buffy coat constituents of the blood sample; and
reducing the rotational speed to cause the spring to expand, capturing the buffy coat constituents in the annular volume.

31. The method of claim 30, wherein the sample tube is a rigid sample tube.

32. The method of claim 30, wherein the sample tube is a flexible sample tube.

33. A flexible volume-occupying separator float, comprising:
an inner core having a top end and a bottom end;
an outer sidewall formed from an optically clear material; and
at least one support member extending radially and connecting the inner core to the outer sidewall.

34. The float of claim 33, further comprising at least one high pressure seal surrounding the outer sidewall.

35. The float of claim 34, comprising a top high pressure seal around a top end of the outer sidewall and a bottom high pressure seal around a bottom end of the outer sidewall.

36. The float of claim 33, wherein the at least one support member is a plurality of axial ridges that extend axially from the top end of the inner core to the bottom end of the inner core.

37. The float of claim 33, wherein the inner core further comprises a pressure relief passage extending between the top and bottom ends of the inner core.

38. The float of claim 33, wherein the inner core has a greater length than the outer sidewall.

39. The float of claim 33, further comprising a bottom end cap for sealing a bottom end of the float, the bottom end cap having a diameter substantially equal to a diameter of the outer sidewall.

40. The float of claim 39, wherein the inner core further comprises an internal passage extending from the bottom end to the top end, and wherein the bottom end cap further comprises a manipulator extending axially through the internal passage.

41. The float of claim 39, wherein the bottom end of the inner core and the bottom end cap comprise a mutual engagement system for connecting the bottom end cap to the inner core.

42. The float of claim 33, further comprising a top end cap for sealing a top end of the float, the top end cap having a diameter substantially equal to a diameter of the outer sidewall.

43. The float of claim 42, wherein the top end of the inner core and the top end cap comprise a mutual engagement system for connecting the top end cap to the inner core.

44. The float of claim 42, wherein the top end cap further comprises a member extending axially away from the float.

45. The float of claim 44, wherein the inner core further comprises an internal passage extending from the bottom end to the top end, and wherein the float further comprises a bottom end cap for sealing a bottom end of the float, the bottom end cap having (i) a diameter substantially equal to the diameter of the outer sidewall and (ii) a manipulator extending axially through the internal passage of the inner core.

46. The float of claim 45, wherein the top end cap member is hollow, and the bottom end cap manipulator extends through the top end cap member.

47. The float of claim 33, further comprising:
a top end cap for sealing a top end of the float, the top end cap having a diameter substantially equal to the diameter of the outer sidewall and including a hollow member extending axially away from the float; and
a bottom end cap for sealing a bottom end of the float, the bottom end cap having a diameter substantially equal to a diameter of the outer sidewall and including a manipulator extending axially through an internal passage of the inner core and through the top end cap hollow member.

48. A method of separating and axially expanding buffy coat constitutents in a blood sample, comprising:
introducing the blood sample into a flexible sample tube, the sample tube having a sidewall;
introducing a volume-occupying float into the sample tube, the float having a specific gravity intermediate that of red blood cells and plasma, and the float comprising:
an inner core having a top end and a bottom end;
an outer sidewall formed from an optically clear material; and
at least one support member extending radially and connecting the inner core to the outer sidewall;
wherein the float engages the sidewall of the sample tube centrifuging the sample tube at a rotational speed that causes enlargement of the sample tube to a diameter sufficiently large to permit axial movement of the float, separation of the blood into discrete layers, and movement of the float into alignment with at least the buffy coat constituents of the blood sample; and
reducing the rotational speed to cause the sidewall of the sample tube to capture the float.

49. The method of claim 48, further comprising analyzing the buffy coat constituents through the optically clear outer sidewall of the float.

50. The method of claim 48, wherein the float further comprises a top high pressure seal around a top end of the outer sidewall and a bottom high pressure seal around a bottom end of the outer sidewall.

51. The method of claim 48, wherein the at least one support member is a plurality of axial ridges that extend axially from the top end of the inner core to the bottom end of the inner core.

52. The method of claim 48, wherein the inner core further comprises a pressure relief passage extending between the top and bottom ends of the inner core.

53. The method of claim 48, wherein the inner core has a greater length than the outer sidewall.

54. The method of claim 48, wherein the float further comprises:
a bottom end cap for sealing a bottom end of the float, the bottom end cap having a diameter substantially equal to a diameter of the outer sidewall; and
a top end cap for sealing a top end of the float, the top end cap having a diameter substantially equal to the diameter of the outer sidewall.

55. The method of claim 54, wherein the inner core further comprises an internal passage extending from the bottom end to the top end, and wherein the bottom end cap further comprises a manipulator extending axially through the internal passage.

56. The method of claim 54, wherein the top end cap further comprises a member extending axially away from the float.

57. The method of claim 56, wherein the inner core further comprises an internal passage extending from the bottom end to the top end, and wherein the float further comprises a bottom end cap for sealing a bottom end of the float, the bottom end cap having (i) a diameter substantially equal to a diameter of the outer sidewall and (ii) a manipulator extending axially through the internal passage of the inner core.

58. The method of claim 57, wherein the top end cap member is hollow, and the bottom end cap manipulator extends through the top end cap member.

59. The method of claim 54, further comprising engaging the top end cap and the bottom end cap with the float to trap the buffy coat constituents in an annular volume between the outer sidewall and the inner core.

60. The method of claim 59, wherein the top end cap and bottom end cap are engaged with the float by welding the top end cap and the bottom end cap to the outer sidewall.

61. The method of claim 60, wherein the top end cap and bottom end cap are engaged with the float by engaging the top end cap and the bottom end cap with the inner core.

62. The method of claim 48, wherein the sample tube comprises one or more circumferential notches on the sidewall of the sample tube to facilitate the breaking of the tube at each notch; and further comprising breaking the sample tube at at least one of the one or more notches to obtain a broken section of the tube containing the float.

63. The method of claim 62, wherein the one or more circumferential notches are located on an exterior surface of the sample tube.

64. The method of claim 62, wherein the one or more circumferential notches are continuous around a circumference of the sample tube.

65. The method of claim 62, wherein the one or more circumferential notches comprise two sets of notches that divide the tube into three volumes.

66. The method of claim 65, wherein one set of notches is above the float and one set of notches is below the float after reducing the rotational speed.

67. The method of claim 66, comprising breaking a notch above the float and breaking a notch below the float to access the float.

68. The method of claim of claim 62, wherein no broken notches are present along the axial length of the float.

69. A method of capturing buffy coat constitutents in a blood sample, comprising:
introducing the blood sample into a flexible sample tube, the sample tube having a sidewall;
introducing a volume-occupying float into the sample tube, and the float comprising:
an inner core having a top end and a bottom end, the inner core having a specific gravity intermediate that of red blood cells and plasma;
an outer sidewall formed from an optically clear material;
at least one support member extending radially and connecting the inner core to the outer sidewall; and
a bottom end cap having a diameter substantially equal to a diameter of the outer sidewall, the bottom end cap being separate from the inner core and the outer sidewall;
wherein the float engages the sidewall of the sample tube;
centrifuging the sample tube at a rotational speed that causes enlargement of the sample tube to a diameter sufficiently large to permit axial movement of the float, separation of the blood into discrete layers, and movement of the inner core into alignment with at least the buffy coat constituents of the blood sample;
reducing the rotational speed to cause the sidewall of the sample tube to capture the float; and
sealing a bottom end of the float by engaging the bottom end of the inner core with the bottom end cap to capture the buffy coat constituents within the float.

70. The method of claim 69, wherein the bottom end of the float is sealed by:
inserting a bottom end cap manipulator through an internal passage in the inner core to engage the bottom end cap; and
pulling the bottom end cap manipulator to engage the bottom end of the inner core with the bottom end cap.

71. The method of claim 69, wherein the bottom end cap comprises a bottom end cap manipulator extending axially through an internal passage in the inner core, and wherein the bottom end of the float is sealed by pulling the bottom end cap manipulator to engage the bottom end of the inner core with the bottom end cap.

72. The method of claim 69, wherein the float further comprises a top end cap having a diameter substantially equal to a diameter of the outer sidewall, the top end cap being separate from the inner core and the outer sidewall, and further comprising:
sealing a top end of the float by engaging the top end of the inner core with the top end cap.

73. The method of claim 72, wherein the top end of the float is sealed by:
engaging the top end cap with a top end cap member; and
pushing the top end cap member to engage the top end of the inner core with the top end cap.

74. The method of claim 72, wherein the top end cap comprises a top end cap member extending axially away from the inner core, and wherein the top end of the float is sealed by pushing the top end cap member to engage the top end of the inner core with the top end cap.

75. The method of claim 69, wherein the sample tube comprises one or more circumferential notches on the sidewall of the sample tube to facilitate the breaking of the tube at each notch; and further comprising breaking the sample tube at at least one of the one or more notches to obtain a broken section of the tube containing the float.

76. The method of claim 75, wherein the one or more circumferential notches are located on an exterior surface of the sample tube.

77. The method of claim 75, wherein the one or more circumferential notches are continuous around a circumference of the sample tube.

78. The method of claim 75, wherein the one or more circumferential notches comprise two sets of notches that divide the tube into three volumes.

79. The method of claim 78, wherein one set of notches is above the float and one set of notches is below the float after reducing the rotational speed.

80. The method of claim 79, comprising breaking a notch above the float and breaking a notch below the float to access the float.

81. The method of claim of claim 75, wherein no broken notches are present along the axial length of the float.
